(19) United States
(12) Patent Application Publication
(10) Pub. No.: US 2009/0008925 A1
(43) Pub. Date: Jan. 8, 2009

(54) SECURITY DEVICE FOR THE IDENTIFICATION OR AUTHENTICATION OF GOODS AND METHOD FOR SECURING GOODS USING SUCH A SECURITY DEVICE

(75) Inventors: Nicolas BLONDIAUX, Neuchatel (CH); Ulrich Gubler, Luzern (CH); Raphael Pugin, Auvernier (CH); Alexander Stuck, Wettingen (CH); Harald Walter, Kilchberg (CH)

Correspondence Address: YOUNG & THOMPSON, 209 Madison Street, Suite 500, ALEXANDRIA, VA, 22314, US

(73) Assignee: CENTRE SUISSE D'ELECTRONIQUE ET DE MICROTECHNIQUE SA

(21) Appl. No.: 12/116,232

(22) Filed: May 7, 2008

Related U.S. Application Data
(60) Provisional application No. 60/916,420, filed on May 7, 2007.

(51) Int. Cl. G06K 19/14; G02B 27/42; G06K 19/16; B42D 15/10

(52) U.S. Cl. 283/85; 359/559; 359/558; 356/71

(57) ABSTRACT

A security device for the identification or authentication of goods is described. It comprises a stochastic pattern comprising structures having an average lateral structure size d and arranged such that an image of at least a part of the security device, when treated through 2D Fourier transformation and calculation of a corresponding Power Spectrum Density, may lead to a peak, in a spatial-frequency domain, having a position in this domain correlated to d and a size distribution value w which, when inverted, is correlated to a size distribution of the structures. The value w according to the invention is smaller than 2/d, so that when directing a coherent light beam on at least part of the structures a ring-shaped scattering speckle pattern is formed, on the basis of which d and w may be calculated to implement identification or authentication of the device.

### TECHNICAL FIELD

The present invention relates to a security device that may be applied on a good to prevent counterfeiting of the latter or to allow its identification or authentication. Examples of goods on which such a mark may be applied are consumer goods and more especially pharmaceutical products. Other examples of goods are banknotes, credit cards, passports, tickets, documents and the like. Furthermore, the invention also concerns a method of identification or authentication of a good based on the use of such a security device.

More particularly, it is intended to provide the security device with a stochastic pattern comprising structures which, upon reading with a specific reader in a specific way, may generate a scattering pattern on the basis of which verification data may be calculated and compared to reference data previously stored in a reference security database in order to identify or verify authenticity of a corresponding good.

### BACKGROUND ART

Counterfeiting of products is a hot topic in many industrial branches like for example textiles, computer software or luxury goods. According to the International Anti-Counterfeiting Coalition (IACC) approximately 7-8% of the trades worldwide are based on forged products. Therefore many different kinds of security features are on the market. As forgers try to imitate all these features there is always a need for new ones to be one step ahead of the forgers. Especially, there is a demand for new security features which can be manufactured with mass production methods as the price must be as low as possible.

Preferably, they should be easily combined with existing features as a combination of two or more security features offers a security level which is not only equal to but more than the sum of the features alone. Such a combination can restore the security level of an existing feature which has already been on the market for some years. E.g. a machine readable security feature which can be manufactured together with holograms has a potential to extend life of the well known and accepted holograms.

Indeed, it is known to use diffractive optically variable image devices (DOVIDs), like holograms, to protect banknotes or credit cards from being counterfeited. Other approaches to prove the originality of items are based on color effects upon tilting (e.g. OVI), magnetic codes or fluorescent dyes. Unfortunately, counterfeiters have already produced forged high-quality versions of devices using all those techniques. Especially DOVIDs possess only a low level of security, because non-experts generally do not know how the holographic image should look like.

Optically variable inks (OVIs) provide a higher level of security compared to DOVIDs, as it is easier for non-experts to observe a color change than a complex image. Unfortunately their effect can be mimicked with color-shifting inks used for decorative purposes that are commercially available from several companies such as JDS Uniphase Corp. (San Jose, USA) or Merck (Darmstadt, USA). This decreases the value of OVIs as anti-counterfeiting tool.

A variety of invisible or covert security features are in the market as well. For example synthetic DNA molecules (U.S. Pat. No. 5,451,505) or micro-particles having several colored layers forming a code (U.S. Pat. No. 6,455,157) are used. It is difficult and/or time consuming to readout the secured information of both techniques.

An identification or authentication device having a material with micro-phase separation, wherein this separation leads to a meso-structure which can be electronically scanned and evaluated based on image recognition is described in DE 102004002410 A1. The meso-structures are large enough to be visible for the human eye. However, the verification based on image recognition is rather slow and rely on expensive verification tools.

A security device comprising a substrate with a random radiation scattering surface or interface is described in the GB 2221870 A. The surface or interface causes an incident, coherent beam of radiation to scatter in a random manner whereby the scattered beams interfere to generate a speckle pattern. The device is identified or authenticated by comparing the speckle pattern with a reference pattern. The complex speckle pattern strongly depends on the measurement position. Thus during the verification process the position of the security device with respect to the reading device must be controlled very precisely.

An authenticity verification method is described in WO 2005/088533 A1 wherein articles are verified by measuring the light which is scattered from their surface. The surface of articles made of paper, cardboard, plastic etc. possesses a unique structure which produces characteristically identifiable signatures in the backscattered light. These signatures can be measured and stored in a reference database. Thus for the verification it is necessary to implement the measuring step at exactly the same position of the article as that of the reference signature creation, which worsen the user-friendliness. Further the measured data must be compared with the data stored in a database. If the database is huge this can be very time consuming.

### SUMMARY OF THE INVENTION

Therefore, there is still a need for security devices that are more difficult to counterfeit and which can be identified or authenticated easily and/or rapidly. Thus, an object of the present invention is to alleviate the drawbacks of the prior art by proposing a security device which presents structural features making it hardly reproducible and, at the same time, readable in efficient and fast ways.

A further aim of the invention is to provide security devices with new security features which are difficult to imitate and at the same time inexpensive to mass produce. Another object of the invention is to provide a security device which may be combined with holograms without increasing the production costs of the holograms distinctly.

For this purpose, the invention relates to a security device of the above-mentioned type comprising at a free surface or at an interface a stochastic pattern comprising structures having an average lateral size distribution d and arranged such that an image of at least part of the security device, when treated through 2D Fourier transformation and calculation of a corresponding Power Spectrum Density, leads to a peak, in a spatial-frequency domain, having a position in this domain leading to a size distribution value w, when inverted, which is correlated to size distribution of the structures. The structures are arranged in such a way that the value w is smaller than 2/d. The structures may be micro- or nanostructures.

Thanks to these features, it is possible to identify the security device by directing a coherent light beam on at least part of the structures. Thus, a ring-shaped scattering speckle pattern is formed, on the basis of which d and w may be calculated to implement identification or authentication of the device.

Consequently, the present invention also relates to a method for securing a good against counterfeiting, comprising the steps consisting in:
producing a security device as mentioned above, comprising structures characterized by a reference average structure size d_{R} and a reference distribution size value w_{R},
recording the average structure size d_{R} and the distribution size value w_{R} in a security reference database,
optionally applying the security device on a surface of the good to be secured,
directing a coherent light beam on at least part of the structures to form a ring-shaped scattering speckle pattern,
measuring the ring-shaped pattern diameter,
calculating a verification average structure size d_{V} on the basis of the diameter,
comparing this verification average structure size d_{V} to reference average structure sizes d_{R} stored in the reference security database,
identifying or authenticating the good if the verification average structure size d_{V} matches one of said reference average structure sizes d_{R} stored in the reference security database.

### BRIEF DESCRIPTION OF THE DRAWINGS

Other features and advantages of the present invention will become more clearly apparent on reading the following detailed description of exemplary embodiments of the present invention, with reference to the appended drawings given by way of non-limiting examples, in which:

FIG. 1a, FIG. 1b and FIG. 1c show Atomic Force Microscopy (AFM) images of stochastically patterned microstructures according to a preferred exemplary embodiment of the invention;

FIG. 2 schematically illustrates a measurement or reading method of a security device according to the present invention;

FIG. 3a shows an image of a pattern resulting from the implementation of the method illustrated on FIG. 2 according to a first embodiment;

FIG. 3b shows a curve corresponding to the light intensity considered along a plane cutting the pattern of FIG. 3a through its center;

FIG. 4a shows an image of a pattern resulting from the implementation of the method illustrated on FIG. 2 according to a second embodiment;

FIG. 4b shows a curve corresponding to the light intensity considered along a plane cutting the pattern of FIG. 4a through its center;

FIG. 5 illustrates, schematically, an exemplary process for fabricating a security device according to an exemplary embodiment of the present invention, and

FIG. 6 illustrates, schematically, an exemplary method for creating reference data to be stored in a reference security database.

### MODE(S) FOR CARRYING OUT THE INVENTION

The present invention aims at providing a security device to help preventing counterfeiting of goods and which can make a corresponding authenticity test of such an item available to a non-expert user as well as easy to carry out.

Prohibiting a reverse analysis of a structure is one of the requirements which must be fulfilled in the field of high security devices.

For that purpose, it is proposed to incorporate in the valuable object a unique stochastic security device, or mark, made of a physical micro- or nanostructure and to devise a method to read, store and recognize that stochastic mark. The stochastic mark should be made hardly or non-replicable, even by the process that created it in the first place.

After marking the object, one can read the mark with a dedicated reading device, and store reference data in a reference security database. To check the authenticity of an item, its stochastic read mark is compared to the one stored in the reference database using a dedicated technique, which reveals if the item is authentic or not.

More precisely, the present invention relates to such security devices the stochastic micro- or nanostructures of which exhibit radiation scattering properties. Scattering is a general physical process. In light scattering, electromagnetic radiation is forced to deviate from a straight trajectory by one or more localized non-uniformities in the medium through which it passes. This also includes deviation of reflected radiation from the angle predicted by the law of reflection.

The radiation scattering structure according to the invention comprises micro- or nanostructures having a predefined average size and/or distance, as well as a predefined size distribution.

Types of non-uniform structures that can cause scattering are e.g. particles, bubbles, droplets, density fluctuations or surface roughness.

Such devices can be used in a variety of applications like, but not restricted to, banknotes, credit cards, passports, tickets, document security, anti-counterfeiting, brand protection and the like.

A specific scattering type is of particular interest for the purpose of implementing the present invention, i.e. coherent backscattering.

This occurs when coherent radiation, like one emitted from a laser beam, propagates through a medium which has a large number of scattering centers. The corresponding waves are scattered many times while travelling through the medium. The effect produces a very large peak in a scattering intensity diagram in the direction back the way the light came.

At angles other than the backscatter direction, the light intensity is subject to numerous essentially random fluctuations called speckles. A speckle pattern is a random intensity pattern produced by the mutual interference of coherent wave fronts that are subject to phase differences and/or intensity fluctuations.

Prominent examples include the seemingly random pattern created when a coherent laser beam is reflected by a rough surface. Each point in the intensity pattern is a superposition of each point of the rough surface contributing to intensity with a random phase due to path length differences.

If the surface is rough enough to create path length differences exceeding a wavelength, the statistics of the speckle field will correspond to a random walk in the complex plane. If the contributions are large, corresponding to a large illuminated surface, the field will follow a circular complex distribution, where both the real and imaginary parts are normally distributed with a zero expected value and the same standard deviations.

Further the real and imaginary parts are uncorrelated. This gives a negative exponential distribution for the intensity. This is the root of the classic speckle appearance—mainly dark areas with bright islands. The formation of such a speckle pattern is due to the high coherence of the laser light. Since variations in the surface are greater than the wavelength, coherent light scattered by the individual elements of the surface interferes to form a stationary pattern. The speckle pattern appears to scintillate or sparkle when there is any relative movement between the surface and the observer.

Scattering surfaces with a broad distribution in the lateral size or diameter of the structures on the surface produce a backscattered speckle pattern in a more or less circular area. If the surface structures possess a narrow size distribution the speckle pattern appears not in the shape of a circular area but of one or several rings around a reflection spot.

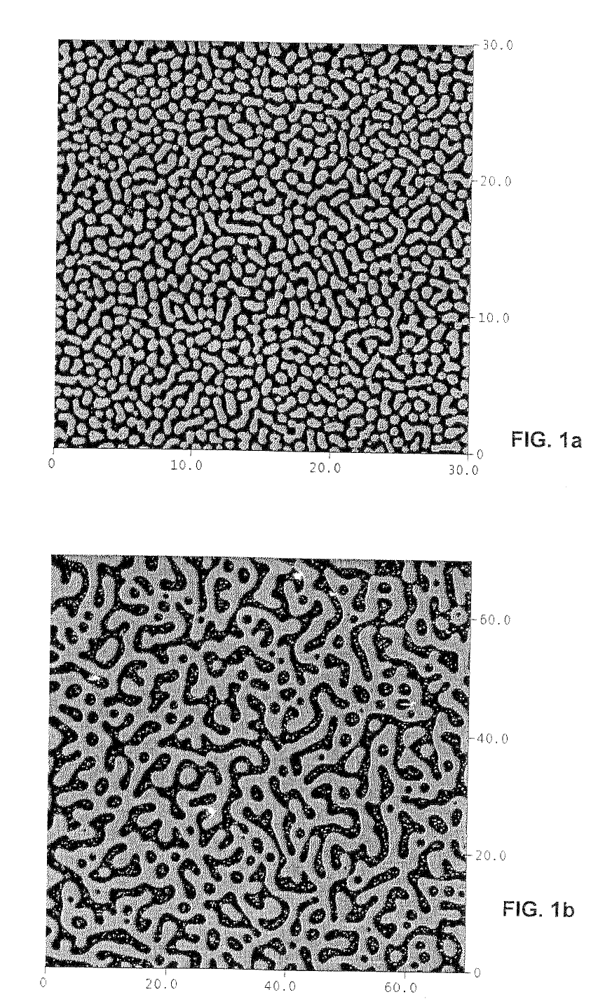

AFM images of examples which are well suited for the implementation of the securing method according to the present invention are shown on FIG. 1a, FIG. 1b and FIG. 1c, the areas scanned by AFM being different between, on the one hand, the first image and, on the other hand, the two last images.

The microstructures represented on these images respectively have well defined average lateral structure sizes of 0.9 μm, 3.4 μm and 6.0 μm. The vertical size is for all microstructures the same and about 10 nm.

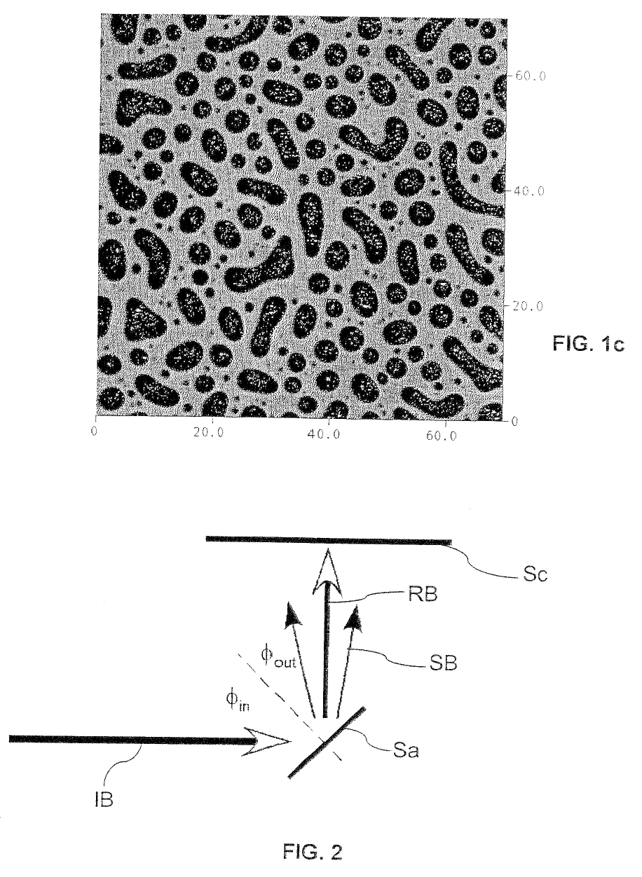

A measuring method can be implemented with a sample Sa, at fixed angle, as schematically illustrated on FIG. 2, where it appears that an incident laser beam IB leads to a central reflected beam RB as well as scattered additional beams SB more or less angled with respect to the central reflected beam RB. The resulting pattern can be made apparent by use of a projection screen Sc or can be measured by a detector array or a CCD camera. This method allows a simple verification of the average structure size and size distribution of samples. Of course the incidence angle is not necessarily 450 as shown in FIG. 2. It can be shallower or steeper or even perpendicular. Preferred are incidence angles between 0° (perpendicular) and 50°, especially preferred between 0° and 25°. In a slightly different embodiment a LED is used as light source instead of a laser. Especially, high-power LEDs can be used. The beam profile of such LED can be optimized by adequate lenses and/or apertures.

As stated above, when the scattering microstructures have a narrow size distribution, the scattering pattern has the shape of one or several rings surrounding the central reflected spot. The diameter of the rings is correlated to the average lateral structure size d and the width of the rings to the size distribution w. The larger the average structure size d the smaller is a ring diameter.

Thus for security devices with scattering surfaces having a well defined lateral structure size and a narrow size distribution, there are two ways to identify the devices.

The lower level of security verification, but faster and easier, is obtained if only the diameter of the ring and thus the average structure size d of the structures is analyzed or detected.

This can be done, according to FIG. 2, by scattering a coherent defocused light beam so as to form a beam spot, or impinging surface, on the structures having a width larger than approximately 500 μm. The light beam should preferably have a spectral width smaller than 100 nm to improve the scattering pattern legibility.

Scattering of visible (wavelength 380 nm-780 nm) or near infrared radiation (wavelength 780 nm-2000 nm) is preferred.

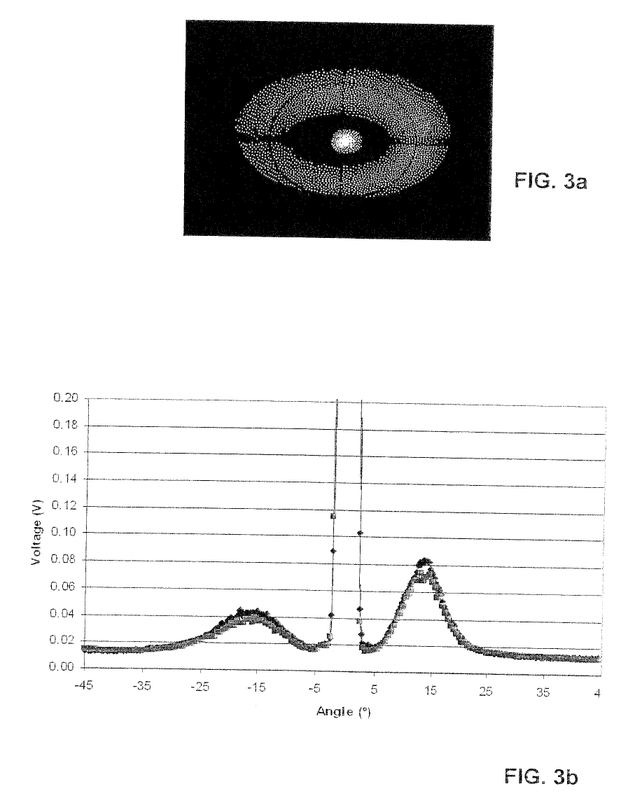

The result of such an operation is shown on FIG. 3a, representing the scattering pattern as visible on the screen, while FIG. 3b represents two different line cuts through the ring center on either sides of the central peak. The difference in the intensity in the left and the right halves respectively is due to a tilt of the sample about a rotation axis symbolized by broken lines on FIG. 2.

The scattering pattern of FIG. 3a was formed on the basis of a defocused laser diode having a wavelength of 638 nm and a spot size of 1220 μm on the sample surface. The distance of the laser to the sample was about 7 cm and the one between sample and projection screen about the same order.

Good respective agreements, on the one hand, of the peak positions and, on the other hand, of the ring widths obviously appear on FIG. 3b. The deflection angle of the intensity maximum in the ring is given by the following equation in which d is the average structure size and/or distance, and K is the wavelength of the laser light and m the deflection order:

d·(sin φᵢₙ−sin φₒᵤₜ)=m·λ

One possible method to extract the information from the scattering measurement is to identify the presence of a peak in a certain angular range or the peak position, e.g. by measuring the scattered intensity with a photodiode array. Another method is to record the whole shape of the scattered intensity curve and compare it with a reference data set in a memory. The width of the ring is defined by the distribution of the structure size.

The higher level of security can be realized by measuring the speckle pattern in the ring which is a fingerprint of the local structure at the position of the security device which is measured.

This can be done, according to FIG. 2, by scattering a coherent focused light beam so as to form a beam spot, or impinging surface, on the microstructures having a width smaller than approximately 500 μm. Here again, the light beam should preferably have a spectral width smaller than 100 nm to improve the scattering pattern legibility.

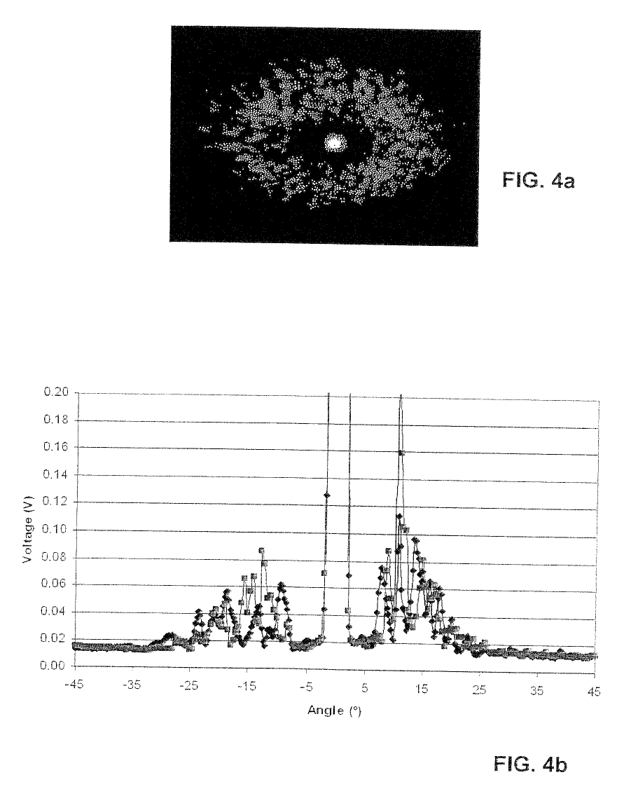

The result of such an operation is shown on FIG. 4a, representing the scattering pattern as visible on the screen, while FIG. 4b represents two different line cuts through the ring center. The difference in the intensity in the left and the right halves respectively is due to a tilt of the sample about a rotation axis symbolized by broken lines on FIG. 2.

The scattering pattern of FIG. 4a was formed on the basis of a focused laser diode having a spot diameter of 35 μm. Again, the distance of the laser to the sample was about 7 cm and the one between sample and projection screen about the same order.

In this embodiment the data can be recorded by a CCD-sensor, for example, or by one or more diode arrays. The data can be compared with a reference data previously recorded in a security reference database.

The first above measuring embodiment offers a fast verification at lower security level, while the second embodiment offers high security verification at lower speed or higher tool costs.

Of course in the focused laser mode a reliable positioning of the measured sample with respect to the verification tool is needed. Lateral position accuracy of the order of 150 μm, in particular ±100 μm, may be needed. Preferred is an accuracy of better than ±80 μm, especially preferred of better than ±50 μm. This can be realized e.g. for credit card by the use of appropriate guide bars or mounts.

Suitable and preferred parameters of the scattering random or stochastic structures are listed in the table 1:

TABLE I

| | | In | | |
|---|---|---|---|---|
| | | particular | | Especially |
| | Suitable | suitable | preferred | preferred |
| parameter | range | range | range | range |
| average structure | 0.05 μm- | 0.5 μm- | 2 μm- | 3 μm- |
| size d | 50 μm | 50 μm | 20 μm | 12 μm |
| size distribution w | w < 2 × d⁻¹ | w < 2 × d⁻¹ | w < d⁻¹ | w < d⁻¹ |
| (PSD-FWHM) | | | | |
| structure depth t | 20 nm- | 50 nm- | 80 nm- | 80 nm- |
| | 2000 nm | 2000 nm | 500 nm | 300 nm |
| ratio t/d | <5/1 | <2/1 | <1/4 | <1/10 |

In the above table, PSD means Power Spectral Density, describing how the power of a signal or time series is distributed with frequency, and, FWHM, Full Width at Half Maximum.

The reason for the preferred limitation of the ratio t/d to values below 2/1 is due to the compatibility of the scattering structures to mass production by embossing, as will be explained later. However, as far as the production of limited series of security devices is concerned, the ratio t/d may be larger than 2/1 without going beyond the scope of the invention.

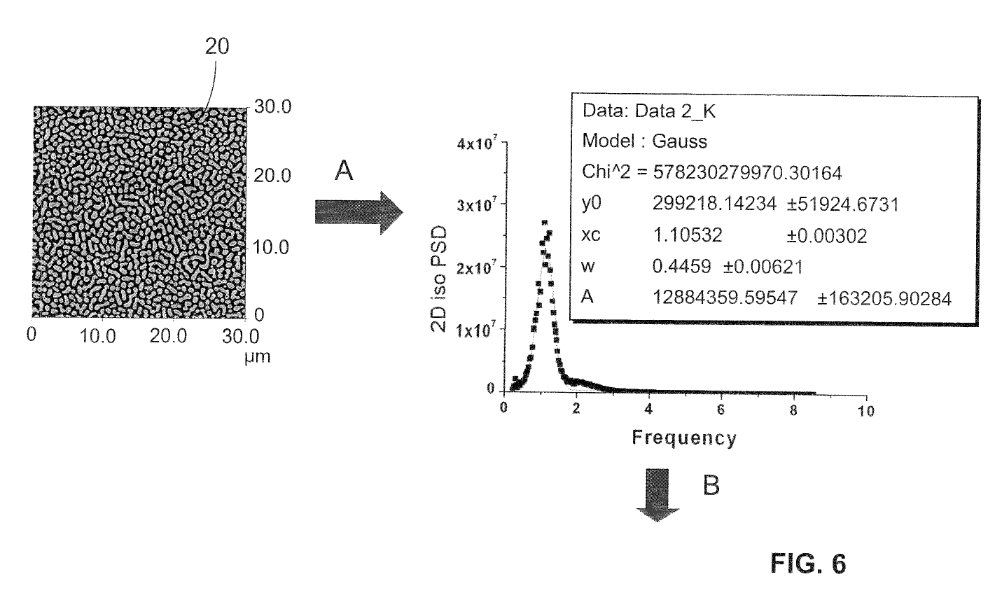

The image of the scattering intensity (FIG. 3a and FIG. 4a) looks very similar to a 2d Fourier transformation of the AFM image of the microstructures. To get quantitative insights of the structure sizes, an image analysis can be performed, as will be detailed later in connection with FIG. 6. Depending on the structure size, images obtained by other techniques like optical microscopes can be analyzed too.

The scattering structures can be at the surface of a security device or at an interface located within it. The latter is possible if at least on one side of the interface the device material is transparent for the wavelength of the light source used in the verification tool. By transparent is meant that the material transmission should be larger than 75%, preferably larger than 90%.

If the scattering structures are at an interface, there must be a difference in the complex index of refraction of the adjacent material to get a contrast for enabling the scattering, as appears from the following equation:

ñ=n−iκ

where n denotes the refractive index indicating the phase velocity v of the light (n=c/v), while K is called the extinction coefficient, which indicates the amount of absorption loss when the electromagnetic wave propagates through a material.

For example the micro- or nanostructures may be embossed in a polymer substrate or an embossable polymer layer on a substrate, the polymer possessing an index of refraction n of about 1.6 and an extinction coefficient close to zero. By coating the embossed surface of the polymer with an aluminum mirror (n≈1.38, κ≈7.63 both at a wavelength of 630 nm) a significant contrast between the index of refraction and the extinction is obtained. This leads to a strong scattering signal which can be measured through the polymer material.

Other possible coatings which induce a step in the index of refraction and/or extinction coefficient are metals like Ag, Cu, Ni, Inconel and Au or dielectric materials like ZnS, TiO₂, Cr₂O₃, AlN, Al₂O₃, HfO₂, Nb₂O₅, Si₃N₄, SnN, Ta₂O₅, V₂O₅, WO₃, or ZrO₂ or high index of refraction polymers like HRI721 and HRI751 (optimate). Preferred are materials that induce an index of refraction step to the polymer of greater than 0.2.

Stochastically arranged topology structures of the desired structure size and with the needed narrow size distribution can be manufactured by several ways like self assembly of polymer blend or block-co-polymer layers, or of bead layers made up of beads with a size in the range of 200 nm up to 2000 nm.

Of course the present invention is not limited to these fabrication processes. All alternate methods capable of realizing the described topography structures are meant to be encompassed within the scope of the invention. Electron-beam lithography and laser writing are two examples of such alternate methods.

Regarding phase separation of polymer blends, this may occur when the system is brought from a stable state (single phase) to an unstable or meta-stable state (biphasic).

There are however different ways to induce phase separation experimentally of which two will be presented, i.e. the temperature-quench and solvent-quench methods.

In the first method, the starting system is a binary polymer blend prepared in the one-phase region to form a homogeneous blend. The system is then subjected to a rapid change in temperature (temperature quench) to bring the blend from the one phase to the two phase region of its phase diagram. One great advantage of the temperature quench approach is that the slow diffusion kinetics of polymer melts allows the different stages of phase separation to be monitored.

The second method uses a ternary system composed of two polymers and a common solvent for both polymers. At low polymer concentrations, the polymer chains are well dissolved and do not interact with neighboring polymer chains. Upon removal of the solvent, the polymer concentration increases until a threshold value above which the system phase separates. The system then undergoes phase separation until it is completely depleted of solvent.

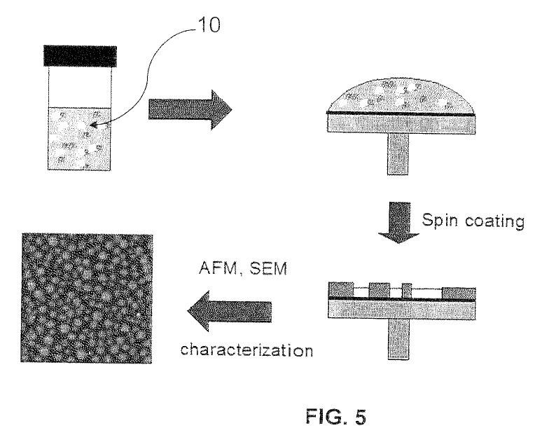

The polymer films made using the solvent quench approach are typically made by means of spin coating, as schematically illustrated on FIG. 5.

This technique is a convenient way to make thin polymer films. When a polymer blend solution 10 comprising a polymer A, a polymer B and a solvent, is spin-coated on a substrate, a thin liquid film first forms due to centrifugal forces. There is then a balance between the centrifugal and viscous forces which determine the thickness of the liquid film formed. In a second stage, the solvent evaporates, which leads to an increase in viscosity and initiates phase separation.

This process produces a rapid quench of the system which is frozen in a non-equilibrium state. In this case the term “solvent quench” is employed. From the theoretical point of view, the solvent quench technique is more difficult to model since it involves additional phenomena to take into account: for instance solvent evaporation which induces an increase of polymer concentration at the free surface, leading to polymer concentration gradients through the depth of the film. It also leads to cooling of the interface (evaporative cooling) which may affect film formation.

From a technological point of view, the solvent quench technique is widely used and many coating techniques (spin-coating, dip-coating, spray-coating) involve solvent quenching.

One great advantage of this technique is the possibility to tune size and morphology of the formed micro- or nanostructures with a diversity of parameters, which is a key point for the development of the structured surfaces.

Potential parameters to tune the structure size and morphologies include the composition of the polymer blend, the molecular weight of the polymers, the spin speed during spin coating, the concentration of the starting solution, the surface energy of the substrate, the evaporation rate of the solvent and humidity of the surrounding air.

As mentioned previously, the developed technology focused on the fabrication, the replication and characterization of randomly structured surfaces. For the fabrication part, various constrains had to be respected:
the structures have to be as random as possible;
the size of the structures must be tunable. For scattering of light in the visible spectral range, the corresponding size range is 0.5 μm to 50 μm. However, smaller size down to 50 nm can be achieved e.g. by using lower concentrations, changing solvent, tuning molecular weight of polymers or by using microphase separation of block copolymers;
the depth of the features has to be highly controlled. Constant depth for all structure sizes facilitates the replication and characterization steps described later in this document.

A well known system for polymer demixing is a blend of polystyrene (PS) and poly methyl methacrylate (PMMA). As illustrated on FIG. 5, solutions of PS/PMMA (30/70)w/w dissolved in toluene were prepared and spin coated on clean silicon wafers.

Then, in a further step, the polystyrene phase may be removed by rinsing the sample in a solvent which is selective for PS, such as cyclohexane. The resulting surface topographies were then characterized using AFM, which leads for example to the images shown on FIG. 1a, FIG. 1b and FIG. 1c.

To tune the size of the microstructures, the polymer concentration of the solution may be adjusted from 1 to 5%_{w/v}. It is already known that a higher concentration leads to thicker films and larger structures.

FIG. 1a, FIG. 1b and FIG. 1c present respective AFM characterizations of respective samples obtained with three different polymer concentrations. As expected, the size of the structures increases when increasing the concentration of the solution. The morphology of the structures obtained is also clearly affected. In the case of the lowest concentration, bumps are obtained in contrast with the pores topography obtained for higher concentrations. The film thickness and the depth of the features is also different, from 30 nm when using a 1%_{w/v} solution, to 125 and 250 nm with 3%_{w/v} and 5%_{w/v} solutions respectively.

To get more quantitative insights on the variations of structure sizes, additional image analysis may be performed, as schematically illustrated on FIG. 6.

This analysis of a raw AFM image 20 allows a determination of the characteristic length-scale of the demixed structures to be conducted. For that purpose, a Fourier analysis may be performed and the power spectrum (2D iso PSD) is calculated on the basis of each of the above-mentioned images. The corresponding power spectrums may then be fitted with Gaussians (step A) and the peak positions (in the spatial-frequency domain) are measured. The length-scales of the structures may then be obtained by calculating the invert of the PSD peak positions (step B).

Through this method, characteristic length-scales of 5.93 μm, 3.38 μm and 0.90 μm for the 5%_{w/v}, 3%_{w/v} and 1%_{w/v} solutions respectively could be determined.

The first described results were satisfying in terms of lateral structure sizes. However, the depth of the features was not controlled and the large features were much deeper than the small ones.

To have the possibility to tune the structure sizes while keeping a constant depth for the features, it is possible to vary the molecular weight of the polymers. As previously mentioned, the phase separation of the polymers strongly depends on their molecular weight. It is known from theory that an important parameter in the present context is the product χN, with χbeing the interaction parameter between the polymers and N the number of monomer block of the polymer chain.

In the case of polymer demixing by solvent quenching, a modification of the molecular weight of the polymers also modifies the viscosity of the solution, which affects the film formation during spin coating. Moreover, once phase separation is initiated, the growth of the micro-o nanostructures also occurs by coalescence. In that case, there is a diffusion of the smaller structures, which coalesce to form larger structures. A change in viscosity also implies a modification of the diffusion and coalescence process. To screen the effect of molecular weight, four different polystyrenes and poly methyl methacrylates with molecular weight from 4 to 600 kDa were used by the Applicant.

While films obtained with low molecular weight polymers were relatively flat without significant nano-topographies, films obtained with higher molecular weights presented more interesting structures with very different structure sizes and morphologies. AFM and Image analysis were then performed to determine the depths and length-scales of the resulting structures. With optimized experimental conditions, surface structures with typical length-scales from 1 μm to 10 μm could be prepared.

In all cases, the depth of the structure was highly controlled and kept constant, around 110±10 nm. This depth is preferred, though not limiting the scope of the invention, because it is enough to give good scattering results while easing the release of the embossing tool from the embossed substrate, in a later replication process. Indeed, if the structures are too deep, the probability that the embossed material sticks to the embossing tool, particularly in roll-to-roll embossing, rises distinctly. On the other hand a minimum structure depth is needed to get a scattering intensity which is high enough.

Therefore it is possible to fabricate random or stochastic structures with different lateral sizes and a constant depth.

Nevertheless, the experiments were made on few cm² silicon samples. To upscale the process to several inch size samples homogeneity problems such as the presence of comets, partial covering of the wafer or chuck marks due to evaporative cooling phenomena had to be solved.

To overcome these problems, the inventors developed strict protocols for the substrate cleaning as well as for the preparation and deposition of the polymer solutions. The arrangement of the structures on 3-inch samples is stochastically like a fingerprint, but the average structure size and/or distance and the distribution of the structure size is well defined.

For mass production the structures may be transferred in an embossing or replication tool, such as Ni shim for roll-to-roll embossing or batch embossing or, tools for injection molding.

The micro- or nanostructures were transferred into such Ni-shims by an electroforming process preformed directly on the 3-inch spin-coated Si-wafers. For this a starting layer was deposited by thermal evaporation of approximately 50 nm Silver. Other possible materials for the starting layer are Au or Ni. Afterwards a 400 μm thick Ni layer was grown in an electroforming Ni-sulfamate bath (Technotrans EFM 2.O2). It is a state-of-the-art process to manufacture batch production shims and embossing rolls for mass production in roll-to-roll embossing machines from such 3-inch shims. This process is widely used for the manufacturing of holograms or DOVIDs. The inventors used the 3-inch shims to hot-emboss the micro- or nanostructures in polymer substrate or foil.

This can be done e.g. by pressing the shim in a 250 μm thick polycarbonate (PC) substrate at a temperature of about 156° C. and with a load of about 80 kg/cm² for approximately 10 minutes. After cooling down to 125° C. the load is removed and the shim separated from the PC substrate.

Suitable materials for the polymer substrate or foil are thermoplastic polymers. E.g. the polymer substrate or foil can be made of acrylonitrile butadiene styrene ABS, polycarbonate PC, polyethylene PE, polyetherimide PEI, polyetherketone PEK, poly(ethylene naphthalate) PEN, poly(ethylene therephtalate) PET, polyimide PI, poly(methyl methacrylate) PMMA, poly-oxy-methylene POM, mono oriented polypropylene MOPP, polystyrene PS, polyvinyl chloride PVC and the like. Alternatively the polymer substrate can be a carrier substrate coated with an embossable layer, e.g. an embossable polymer layer.

By coating the embossed polymer substrate or foil with an evaporated 70 nm thick Al mirror layer, demonstrator samples with good light scattering properties were realized. All three samples with the different microstructure sizes as described above showed nearly the same optical appearance to the human eye. Adhesive labels were made from these demonstrator samples by applying a glue layer and a silicon coated paper as glue protection on the back side. All techniques to apply embossed holograms to goods, e.g. lamination or hot transfer, are suitable for the security feature described in this document as well.

As the above-described fabrication process is fully compatible to the established manufacturing process of holograms and DOVIDs it may offer a way to make these overt features machine readable and thus improve their security level distinctly. This may be realized e.g. by incorporating in an embossing roll, besides a hologram, an area of e.g. 5×5 mm² with such replicated self-assembled microstructures. The machine readable micro-structured area would appear as an inconspicuous metallic scattering area close to the hologram.

A preferred first general method for securing a good against counterfeiting taking advantage of the security device according to the present invention may comprise the steps consisting in
producing a security device according to the above description, comprising structures characterized by a reference average structure size d_{R} and a reference distribution size value w_{R},
recording the average structure size d_{R} and the distribution size value w_{R} in a security reference database,
optionally applying the security device on a surface of the good,
directing a coherent light beam on at least part of the structures to form a ring-shaped scattering speckle pattern, measuring the ring-shaped pattern diameter,
calculating a verification average structure size d_{V} on the basis of the diameter,
comparing this verification average structure size d_{V} to reference average structure sizes d_{R} stored in the reference security database,
identifying or authenticating the good if the verification average structure size d_{V} matches one of the reference average structure sizes d_{R} stored in the reference security database.

A second method for securing a good against counterfeiting taking advantage of the security device according to the present invention may comprise the steps consisting in:
producing a security device according to the above description, comprising structures characterized by a reference average structure size d_{R} and a reference distribution size value w_{R},
recording characteristic features of a line scan through the ring-shaped scattering speckle pattern, in particular the peak position and the peak width, in a security reference database,
optionally applying the security device on a surface of the good,
directing a coherent light beam on at least part of the structures to form a ring-shaped scattering speckle pattern,
measuring the characteristic features of a line scan through the ring-shaped scattering speckle pattern,
comparing the measured characteristic features to the reference characteristic features in the reference security database,
identifying or authenticating the good if the measured characteristic features matches one of the reference characteristic features stored in the reference security database.

As previously stated, such methods may be implemented on the basis of a coherent light beam having, preferably, a spectral width smaller than 100 nm and being defocused so as to form a beam spot on the structures having a width larger than approximately 500 μm.

The first above method may further comprise additional or alternate steps consisting in:
measuring the ring-shaped pattern width,
calculating a verification distribution size value w_{V} on the basis of the width,
comparing this verification distribution size value w_{V} to reference distribution size values w_{R} stored in the reference security database,
identifying or authenticating the good if the verification distribution size value w_{V} matches one of the reference distribution size values w_{R} stored in the reference security database.

An alternate more precise method would be to provide a coherent light beam having a spectral width smaller than 100 nm and being focused so as to form a beam spot on the structures having a width smaller than approximately 500 μm, preferably smaller than 50 μm. The thus formed scattering ring pattern may play the role of a fingerprint to be compared with reference fingerprints recorded in a reference security database.

The above description corresponds to preferred embodiments of the invention described by way of non-limiting examples. The one skilled in the art will encounter no particular difficulty to adapt either part of the fabrication processes or identification method with respect to his needs without going beyond the scope of the present invention.

Obviously, the security device image data may be combined to further complementary information in the reference security database, such as a metadata of the secured valuable item which may include a set of data of commercial interest for the application that uses the anti-counterfeiting method (i.e. name of the owner, ownership history, authenticity check history, name of the expert who created the reference data, date and place of fabrication, etc . . . ), or possibly a visual of the item. In that case, the recognition method may include additional checking operations related to this complementary information.

1. A security device for the identification or authentication of goods containing a stochastic pattern comprising structures at a free surface or at an interface of said security device having an average lateral structure size d and arranged such that an image of at least part of said security device, when treated through 2D Fourier transformation and calculation of a corresponding Power Spectrum Density, leads to a peak, in a spatial-frequency domain, having a position in said domain correlated to d and a width of which value w is smaller than 2/d, said width, when inverted, being correlated to a size distribution of said structures.

2. The security device of claim 1, wherein said peak is fitted with a Gaussian curve before calculation of said value w.

3. The security device of claim 1, wherein said value w is smaller than 1/d.

4. The security device of claim 1, wherein said structures are micro- or nanostructures.

5. The security device of claim 1, wherein said average lateral structure size d is included within a suitable range going approximately from 0.05 to 50 μm, in particular suitable from 0.5 to 50 μm, preferably from 2 to 20 μm, more preferably from 3 to 12 μm.

6. The security device of claim 1, wherein said structures have a depth t included within a suitable range going approximately from 20 to 2000 nm, in particular suitable from 50 to 2000 nm, preferably from 80 to 500 nm, more preferably from 80 to 300 nm.

7. The security device of claim 6, wherein a ratio defined by t/d is smaller than 5, in particular smaller than 2, preferably smaller than ¼, more preferably smaller than 1/10.

8. The security device of claim 1, wherein said structures are located on a free surface of said security device.

9. The security device of claim 1, wherein said structures are covered by a material layer which presents a transmission yield of at least 75%, preferably of at least 90%, for a predefined wavelength of light.

10. The security device of claim 1, wherein said structures are coated with a material chosen from the group comprising: Al, Ag, Cu, Ni, Au, Inconel, dielectric materials like ZnS, TiO₂, Cr₂O₃, AlN, Al₂O₃, HfO₂, Nb₂O₅, Si₃N₄, SnN, Ta₂O₅, V₂O₅, WO₃, ZrO₂, high index of refraction polymers like HRI721, HRI751.

11. A method for securing a good against counterfeiting, comprising steps consisting in:
producing a security device according to claim 1, comprising structures characterized by a reference average structure size d_{R} and a reference distribution size value w_{R},
recording said average structure size d_{R} and said distribution size value w_{R} in a security reference database,
optionally applying said security device on a surface of said good,
directing a coherent light beam on at least part of said structures to form a ring-shaped scattering speckle pattern,
measuring said ring-shaped pattern diameter,
calculating a verification average structure size d_{V} on the basis of said diameter,
comparing said verification average structure size d_{V} to reference average structure sizes d_{R} stored in said reference security database,
identifying or authenticating said good if said verification average structure size d_{V} matches one of said reference average structure sizes d_{R} stored in said reference security database.

12. The method according to claim 11, comprising further steps consisting in:
measuring said ring-shaped pattern width,
calculating a verification distribution size value w_{V} on the basis of said width,
comparing said verification distribution size value w_{V} to reference distribution size values w_{R} stored in said reference security database,
identifying or authenticating said good if said verification distribution size value w_{V} matches one of said reference distribution size values w_{R} stored in said reference security database.

13. The method according to claim 11, wherein said coherent light beam has a spectral width smaller than 100 nm and is defocused so as to form a beam spot on said structures having a width larger than approximately 500 μm.

14. A method for securing a good against counterfeiting, comprising steps consisting in:
producing a security device according to claim 1, comprising structures characterized by a reference average structure size d_{R} and a reference distribution size value w_{R} smaller than 2/d_{R},
producing a reference scattering pattern fingerprint by scattering a coherent light beam having a spectral width smaller than 100 nm and being focused so as to form a beam spot on said structures having a width smaller than approximately 500 μm, preferably smaller than 50 μm,
recording said reference scattering pattern fingerprint in a security reference database,
optionally applying said security device on a surface of said good,
directing a coherent light beam having a spectral width smaller than 100 nm and being focused so as to form a beam spot on said structures having a width smaller than approximately 500 μm, preferably smaller than 50 μm, to check said security device by obtaining a verification scattering pattern fingerprint,
comparing said verification scattering pattern fingerprint to reference scattering pattern fingerprint stored in said reference security database,
identifying or authenticating said good if said verification scattering pattern fingerprint matches one of said reference scattering pattern fingerprint stored in said reference security database.

15. The method according to claim 12, wherein said coherent light beam has a spectral width smaller than 100 nm and is defocused so as to form a beam spot on said structures having a width larger than approximately 500 μm.
